(19) United States
(12) Patent Application Publication
(10) Pub. No.: US 2023/0238029 A1
(43) Pub. Date: Jul. 27, 2023

(54) SIDE ERASE MEASURING METHOD AND REFRESH PROCESS METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Ryuichi SATO, Kawasaki Kanagawa (JP)

(21) Appl. No.: 17/860,555

(22) Filed: Jul. 8, 2022

(30) Foreign Application Priority Data
Jan. 27, 2022 (JP) 2022-010989

(51) Int. Cl. G11B 19/04; G11B 5/09; G11B 5/024; G11B 5/56

(52) U.S. Cl. CPC G11B 19/045; G11B 5/09; G11B 5/024; G11B 5/56

(57) ABSTRACT

According to one embodiment, a side erase measuring method includes selecting one center track, and a plurality of target sectors, selecting a bit error rate (BER) measuring sector to measure a BER from the target sectors in the peripheral tracks such that sectors differ between adjacent peripheral tracks, counting a center track write number, and measuring BER in the BER measuring sector per a predetermined number of the center track write number.

### CROSS-REFERENCE TO RELATED APPLICATIONS

This application is based upon and claims the benefit of priority from Japanese Patent Application No. 2022-010989, filed Jan. 27, 2022, the entire contents of which are incorporated herein by reference.

### FIELD

Embodiments described herein relate generally to a side erase measuring method and a refresh process method.

### BACKGROUND

In magnetic disk devices, when data are written to a disk, such data may be erased because of an influence of flux leaked from a head or the like (adjacent track interference: ATI), which is referred to as side erase. Different ATIs are caused based on head characteristics, track per inch (TPI) setting values, and write current setting values. In order to prevent the side erase, magnetic disk devices have a function to rewrite data of a certain track when the number of write of data to peripheral tracks of the certain track reaches a predetermined number (which may be referred to as refresh function or ATI refresh function). A trigger used to start the refresh function may be a track profile indicative of influential degree of side erase.

However, depending on methods of acquiring track profile, the refresh function may not perform well, and rewrite is not performed timely.

The embodiments of the present application will present a side erase measuring method and a refresh process method, which are to improve the reliability of data.

### BRIEF DESCRIPTION OF THE DRAWINGS

FIG. 1 is a structural diagram of a magnetic disk device of a first embodiment.

FIG. 2 is a schematic diagram illustrating an area of a disk of the first embodiment.

FIG. 3 is a flowchart illustrating processing actions of a refresh process executed by the magnetic disk device of the first embodiment.

FIG. 4 is a schematic view illustrating a side erase measuring method with respect to the magnetic disk device of the first embodiment.

FIG. 5 is a flowchart of steps of BER measurement of the side erase measuring method with respect to the magnetic disk device of the first embodiment.

FIG. 6 is a diagram illustrating an example of effect of side erase per track, acquired by a side erase measuring method of the first embodiment.

FIG. 7 is a diagram illustrating an example of write number dependency, acquired by the side erase measuring method of the first embodiment.

FIG. 8 is a diagram illustrating an example of write number threshold value per track, acquired by the side erase measuring method of the first embodiment.

FIG. 9 is a diagram illustrating an example of a track profile weight table acquired by a side erase measuring method of a second embodiment.

FIG. 10 is a flowchart illustrating processing actions of a refresh process executed by a magnetic disk device of the second embodiment.

FIG. 11 is a flowchart illustrating processing actions of a refresh process executed by a magnetic disk device of a third embodiment.

FIG. 12 is a schematic view of a side erase measuring method with respect to a magnetic disk device of a variation.

### DETAILED DESCRIPTION

In general, according to one embodiment, a side erase measuring method used in a disk-shaped magnetic disk including a plurality of tracks which are areas defined concentrically from a center part in a radial direction and a plurality of sectors defined in a circumferential direction, the method include selecting one center track from the tracks and a plurality of peripheral tracks continuous from tracks adjacent to the center track concentrically outward and inward in the radial direction, and a plurality of target sectors, selecting a bit error rate (BER) measuring sector to measure a BER from the target sectors in the peripheral tracks such that sectors differ between adjacent peripheral tracks, counting a center track write number which is a write number per write of data to all the target sectors of the center track, and measuring BER in the BER measuring sector per a predetermined number of the center track write number.

Hereinafter, embodiments will be described with reference to the accompanying drawings. Note that, the drawings are only an example and do not limit the scope of the invention.

### First Embodiment

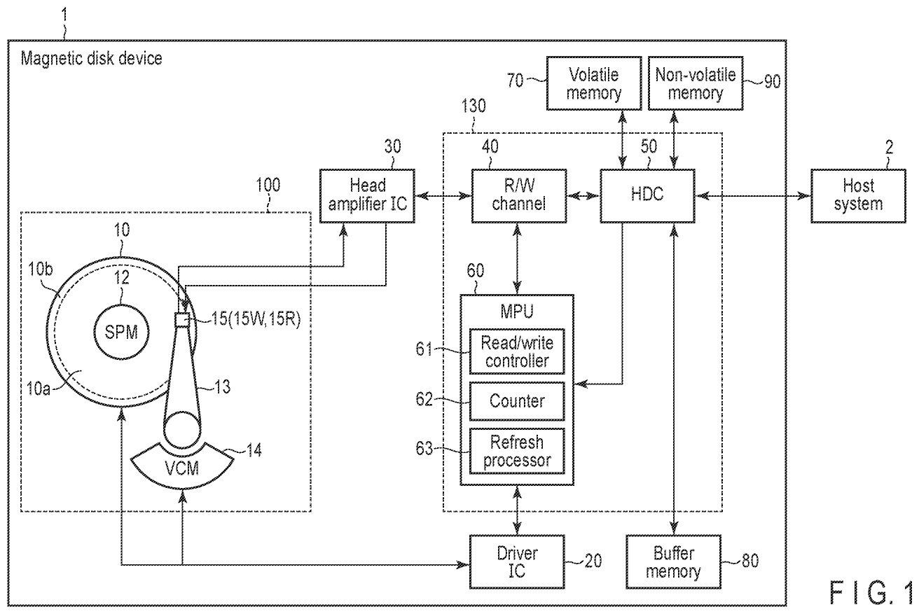

FIG. 1 is a structural diagram of a magnetic disk device of the first embodiment.

The magnetic disk device 1 includes a head disk assembly (HDA) 100, which will be described below, driver IC20, head amplifier IC30 which is a head amplifier integrated circuit, volatile memory 70, buffer memory (buffer) 80, non-volatile memory 90, and system controller 130 which is a single-chip integrated circuit. Furthermore, the magnetic disk device 1 is connected to a host system 2.

The host system 2 is, for example, a personal computer that outputs data read/write commands to the magnetic disk device 1. The host system 2 may also include programs for BER measurement and may control the magnetic disk device 1 in BER measurement.

The HDA100 includes a magnetic disk (hereinafter referred to as disk) 10, spindle motor (hereinafter referred to as SPM) 12, arm 13 which mounts a head 15, and voice coil motor (hereinafter referred to as VCM) 14.

The disk 10 is mounted on the spindle motor 12, and is rotated by drive of the spindle motor 12. The arm 13 and the VCM 14 structure an actuator. By drive of the VCM 14, the head mounted on the arm 13 is moved to a target position on the disk 10. The number of the disk 10 and the head 15 may be two or more.

The disk 10 is a disk-shaped rotatable disk storage medium, and in the area where data can be written, a user data area 10a which is available for the user, and a system area 10b where information necessary for system management is written are allocated. In the following description, a direction orthogonal to the radial direction of the disk 10 will be referred to as circumferential direction.

The spindle 12 is a prop of the disk 10 and is installed in the casing of the magnetic disk or the like. The rotation of the spindle 12 causes the disk 10 to rotate.

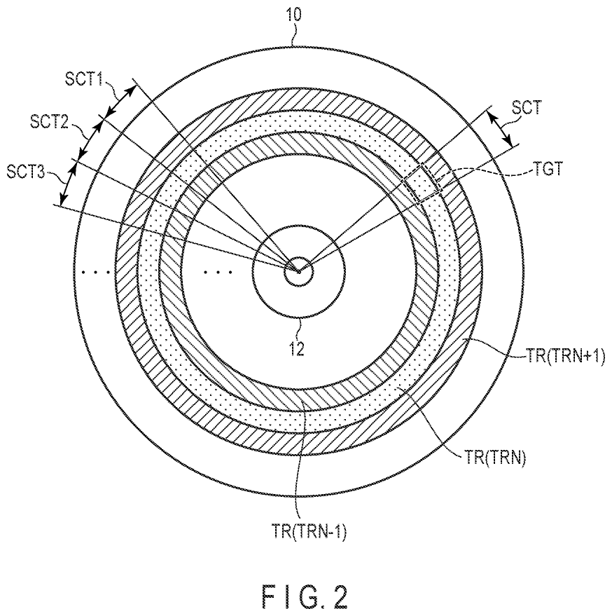

FIG. 2 is a schematic diagram of the structure of the magnetic disk of the first embodiment.

The disk 10 includes a plurality of tracks TR set concentrically around the spindle 12, and a plurality of sector regions SCT in the circumferential direction. Data are written to the tracks TR, and the head 15 writes data in each sector area SCT of the track TR, or reads the written data therein. The intersection of track TR and sector area SCT will be referred to as target data sector TGT.

A track TR(TRN) indicates a track TR with a track number TRN. For example, track TR with track number 0 will be indicated as track TR(0). Similarly, TR(TRN+1), TR(TRN−1) adjacent to TR(TRN) will be referred to as adjacent tracks of TR(TRN).

Referring back to FIG. 1, the arm 13 is an arm that supports the head 15, and transfers motion from the VCM 14 to the head 15 to move the head 15 to the target data sector TGT.

The VCM 14 is a voice coil motor for moving the arm 13.

The head 15 includes a slider as the main body thereof, and a write head 15W and a read head 15R mounted on the slider. The write head 15W writes data to the disk 10. The read head 15R reads data recorded on the data track of the disk 10.

The driver IC 20 controls the SPM 12 and the VCM 14 in accordance with the system controller 130.

The head amplifier IC 30 includes a read amplifier and a write driver. The read amplifier amplifies read signals read from the disk 10 and outputs the amplified signals to the system controller 130. The write driver outputs write current corresponding to the signals output from the R/W channel 40 to the head 15.

The volatile memory 70 is a semiconductor memory which loses data stored therein when the power supply is cut off. The volatile memory 70 stores data and other data necessary for processing of the magnetic disk device 1. The volatile memory 70 is, for example, a dynamic random access memory (DRAM), or synchronous dynamic random access memory (SDRAM).

The buffer memory 80 is a semiconductor memory which temporarily records data or the like transmitted and received between the magnetic disk device 1 and the host system 2. Note that, the buffer memory 80 may be configured integrally with the volatile memory 70. The buffer memory 80 is, for example, a DRAM, static random access memory (SRAM), SDRAM ferroelectric random access memory (FeRAM), or magnetoresistive random access memory (MRAM).

The nonvolatile memory 90 is a semiconductor memory which records stored data even when the power supply is cut off. The nonvolatile memory 90 is, for example, a NOR or NAND flash read only memory (FROM).

The system controller 130 may be realized using, for example, a large-scale integrated circuit (LSI) which will be referred to as system-on-a-chip (SoC) in which a plurality of elements are integrated into a single chip. The system controller 130 includes a read/write (R/W) channel 40, hard disk controller (HDC) 50, and microprocessor (MPU) 60. The system controller 130 is electrically connected to, for example, the driver IC 20, head amplifier IC 30, volatile memory 70, buffer memory 80, nonvolatile memory 90, and host system 2.

The R/W channel 40 performs signal processing of read data transferred from the disk 10 to the host system 2 and write data transferred from the host system 2 in response to instructions from the MPU 60, which will be described later. The R/W channel 40 includes a circuit to measure signal quality of the read data or a function to perform the same. The R/W channel 40 is electrically connected to the head amplifier IC 30, HDC50, MPU 60.

The HDC50 serves as the interface between the magnetic disk device 1 and the host system 2, and receives commands from the host system 2 such as data write commands to the disk 10 and data read commands from the disk 10. The HDC50 controls internal components of the magnetic disk device 1 and transfers data between the host system 2 and the R/W channel 40. The HDC50 is electrically connected to, for example, the R/W channel 40, MPU 60, volatile memory 70, buffer memory 80, and nonvolatile memory 90.

The MPU60 is a main controller which controls each component of the magnetic disk device 1. The MPU60 controls the VCM14 via the driver IC 20, and executes servo control for positioning the head 15. The MPU60 controls the write operation of data to the disk 10 and selects the destination for storing the write data. Furthermore, the MPU60 controls the read operation of data from the disk 10, and controls the processing of read data. The MPU60 is connected to each part of the magnetic disk device 1. The MPU60 is electrically connected to, for example, the driver IC 20, R/W channel 40, and HDC50.

The MPU 60 includes a read/write controller 61, counter 62, and refresh processor 63. The MPU 60 executes the processing of, for example, the read/write controller 61, counter 62, and refresh processor 63, using programs such as firmware. Note that, the MPU 60 may include each of such components as hardware such as circuitry.

The read/write controller 61 controls data read processing and data write processing according to commands from the host system 2. The read/write controller 61 controls the VCM 14 via the driver IC 20, and positions the head 15 at a target position of the disk 10 to read or write data.

The counter 62 is used to count the number N(TRN) indicating how many times data have been written to track TR(TRN) (hereinafter referred to as count number or write number) for each track TR(TRN). The counter 62 counts the number of write counts N(TRN) per track TR and per sector SCT, and in that case, the write counts will be indicated as N(TRN, SCTN), where SCTN indicates the sector number. Furthermore, the counter 62 may count the number N_A(TRN) of adjacent write counts when data are written to tracks TR(TRN+1) and TR(TRN−1) adjacent to the track TR(TRN).

The refresh processor 63 executes refresh processing (or may be simply referred to as refresh). The refresh processing is a process for reducing the effects of side erase caused by adjacent track interference in the disk 10. For example, in the refresh process, data written to a specific recording area on the disk 10 are read once and the read data are rewritten to the specific recording area. The data written to the disk 10 may sometimes be altered when data are written to adjacent tracks thereof, for example, and such altered data cannot be read (and this phenomenon is generally referred to as side erase). The effect of side erase can be reduced by the refresh process. The refresh processor 63 executes the refreshing process of data of the adjacent tracks or peripheral tracks including the adjacent tracks based on the number of write counts N(TRN) counted by the counter 62 and a preset threshold (which will be referred to as refresh threshold).

Since the side erase may affect tracks distant from the written (data-written) track (referred to as write track), there is a track profile weight table which weights the degree of erase influence on the peripheral tracks. The refresh threshold is determined based on the track profile weight table, and the determination method will be described later.

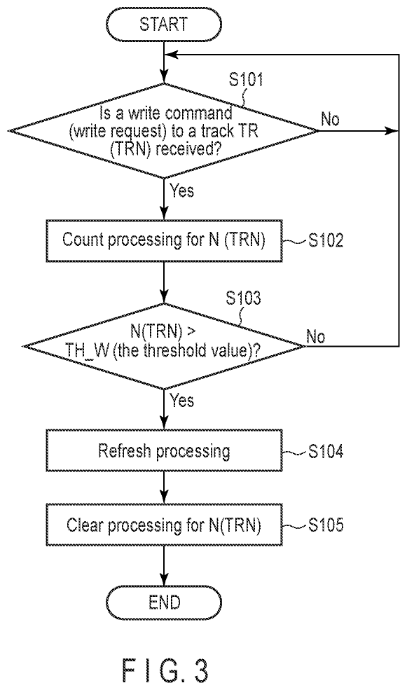

FIG. 3 is a flowchart illustrating processing actions of the refresh process performed by the magnetic disk device of the first embodiment.

The HDC 50 receives a data write command (write request) to a track TR(TRN) of track number TRN from the host 2 (Step S101). The HDC 50 sends the write request together with the data to the read/write controller 61, and also orders the counter 62 to count the write number N(TRN) which indicates the write counts to the track TR (Step S102).

The counter 62 compares N(TRN) with the threshold value TH_W, and if N(TRN)>TH_W (Yes in Step S103), orders the refresh processor 63 to perform refresh processing (step S104). In step S104, data of the adjacent tracks TR(TRN-1) and TR(TRN+1) or the data of the peripheral tracks including the adjacent tracks are refreshed. Upon completion of the execution of step S104, the counter 62 clears N(TRN) (step S105). In step S103, the write number N(TRN) of the tracks TR(TRN) is equal to or less than the threshold value TH_W, a next write request is awaited (No in Step S103).

The threshold TH_W in step S103 is determined from, for example, the track profile which indicates the degree of influence of side erase obtained by separate evaluation. In the present embodiment, side erase is measured considering the effect of data write to adjacent tracks.

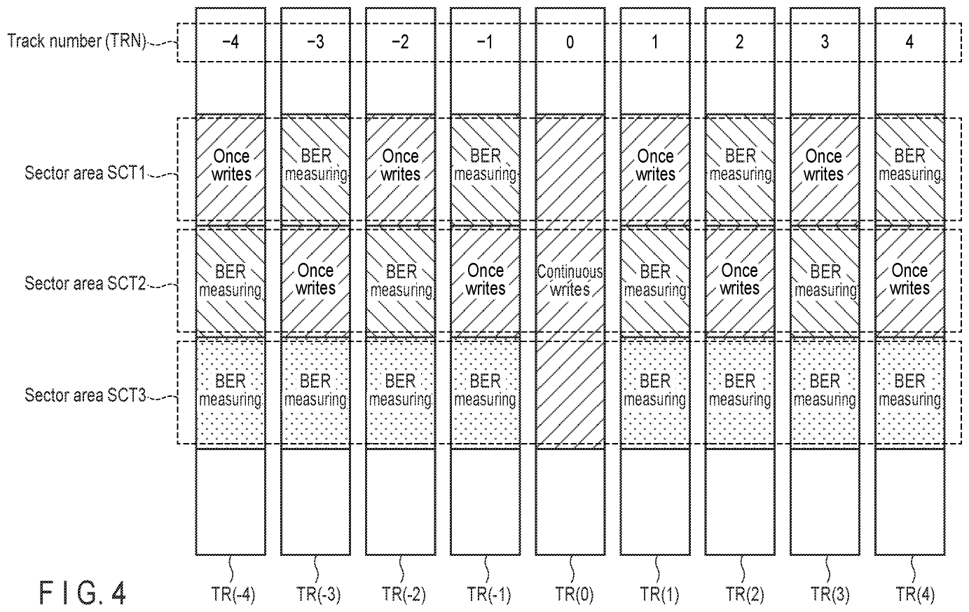

FIG. 4 is a schematic view illustrating a side erase measuring method with respect to the magnetic disk device of the first embodiment, in which bit error rate (BER) is used as the evaluation criteria for side erase.

Track TR(0) will be referred to as center track, and tracks on both sides of track TR(0) will be referred to as peripheral tracks. In the side erase measurement of the present embodiment, the effect of side erase on the peripheral tracks when data are repeatedly written (overwritten) to track TR(0) is measured. In FIG. 4, eight tracks TR(−4) to TR(−1), TR(1) to TR(4) are shown as peripheral tracks. BER is measured on the peripheral tracks, and as in FIG. 4, a position subjected to the BER measurement is determined per sector area of the peripheral tracks (SCT1, SCT2, and SCT3). In the example of FIG. 4, in sector area SCT1, BER is measured on the peripheral tracks TR(−3), TR(−1), TR(2), and TR(4), and in the peripheral tracks TR(−4), TR(−2), TR(1), and TR(3), BER is measured in sector area SCT2, which is different from sector area SCT1. In sector area SCT3 which is different from the sector areas SCT1 and SCT2, BER is measured on all tracks except TRO. The area where BER is measured will be referred to as BER measurement area. In the present embodiment, the BER measurement area is allocated to sector of each peripheral track, and the allocated sector will be referred to as BER measuring sector. That is, the tracks where BER is measured are allocated to the sector areas SCT1 and SCT2 such that the tracks where BER is measured are not adjacent to each other in the sector areas SCT1 and SCT2. Thus, BER measurement with respect to different sector SCT for each adjacent peripheral track TR can be performed.

To perform the BER measurement, for example, known data may be written in advance in the BER measurement area, and the host system 2 reads the data from the BER measurement area and compares the read data with the known data.

In the peripheral tracks where BER is measured, one or more writes are performed in the area other than the area of BER measurement before consecutive writes are performed to track TR(0) as the center tracks, or after the specific number of consecutive writes is made to track TR(0). The sector to be written one or more times in the peripheral tracks will be referred to as write sector. As in FIG. 4, one write is made to sector area SCT2 with respect to tracks TR(−3), TR(−1), TR(2), and TR(4), and one write is made to sector area SCT1 with respect to tracks TR(−4), TR(−2), TR(1), and TR(3). Then, BER of the BER measurement area allocated to each sector area SCT1, SCT2, and SCT3 is measured. Thus, BER measurement performed in consideration of not only the effect from track TR(0) to the BER measurement area, but also the effect of the adjacent tracks in the BER measurement area is achieved. Furthermore, in sector area SCT3, BER measurement is performed without writing to all peripheral tracks. This enables BER measurement in sector area SCT3 when there is no influence from adjacent tracks to the BER measurement area. That is, in the present embodiment, BER measurements can be performed simultaneously with and without the influence of adjacent tracks on the BER measurement area.

Then, the continuous writes to track TR(0) is performed, and for each specific number of continuous writes, BER is measured with respect to the BER measurement area. This is repeated until the specific number of writes is reached, and dependence of write number of BER is obtained.

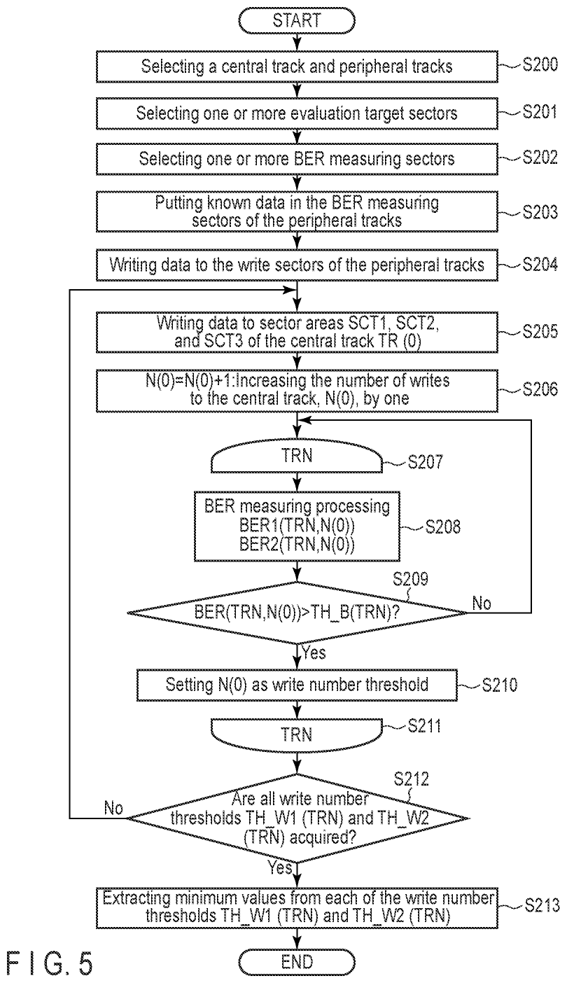

FIG. 5 is a flowchart illustrating the procedure of BER measurement of the side erase measuring method with respect to the magnetic disk device of the first embodiment, and the process according to the present flowchart may be executed by software implemented in the host system 2, for example.

A central track TR and peripheral tracks TR of the disk 10 to be subjected to BER measurement is selected (Step S200). FIG. 4 illustrates an example where TRN=0 is selected for the central track TR, and TRN=−4 to 4 (except 0) is selected for the peripheral tracks. A sector area SCT of the disk 10 to be subjected to BER measurement in the peripheral tracks TR selected in TR step S200 is selected (Step S201). The sector area SCT selected in step S201 is referred to as evaluation target sector SCT. In FIG. 4, sector areas SCT1, SCT2, and SCT3 each correspond to the evaluation target sector SCT.

BER measuring sector is allocated with respect to the evaluation target sector SCT selected in step S201 (Step S202). Specifically, as in FIG. 4, in the peripheral tracks TR(−3), TR(−1), TR(2), TR(4), sector area SCT1 is the BER measuring sector, and in the peripheral tracks TR(−4), TR(−2), TR(1), and TR(3), sector area SCT2 is the BER measuring sector, and furthermore, the sector area SCT3 for all peripheral tracks TR(−4), TR(−3), TR(−2), TR(−1), TR(1), TR(2), TR(3), and TR(4) are the BER measuring sectors.

Known data are put in the BER measuring sectors of the peripheral tracks (Step S203). The known data in step S203 are the data for BER measurement. In step S203, the known data may be put in all the evaluation target sectors SCT in the peripheral tracks.

Data are once written to the write sectors of the peripheral tracks (Step S204). Specifically, as in FIG. 4, data are written once to the sector area SCT2 of the peripheral tracks TR(−3), TR(−1), TR(2), and TR(4), and to the sector area SCT1 of the peripheral tracks TR(−4), TR(−2), TR(1), and TR(3) (Step S204). According to step S204, the influence of adjacent tracks on the BER measuring sectors of the peripheral tracks can be taken into consideration. Note that, the data write to write sectors in step S204 may be performed once or more.

Data are written once to sector areas SCT1, SCT2, and SCT3 of the central track TR(0) (Step S205). The counter 62 increases the number N of writes to the central track TR(0) by one (Step S206).

BER measurement is performed with respect to the BER measurement areas shown in FIG. 4, and the number of writes N(0) and BER per peripheral track TR(TRN), BER(TRN, N(0)), are acquired (Steps S207 to S211). Steps S207 and S211 indicate repeating steps S208 to S210 with respect to all peripheral tracks TR(TRN).

BER measurement is performed with respect to all peripheral tracks TR(TRN) (Step S208). BER with respect to track TR(TRN) will be BER1(TRN, N(0)) when the influence of adjacent tracks is considered, and BER2(TRN, N(0)) when the influence of adjacent tracks is not considered, and the above two will be collectively referred to as BER(TRN, N(0)).

Specifically, for example, in FIG. 4, with respect to tracks TR(−3), TR(−1), TR(2), and TR(4), from a result of the BER measurement of the sector area SCT1, BER1(TRN, N(0)) when the influence of adjacent tracks is considered is obtained. Furthermore, with respect to tracks TR(−4), TR(−2), TR(1), and TR(3), from a result of the BER measurement of the sector area SCT2, BER1(TRN, N(0)) when the influence of adjacent tracks is considered is obtained.

Furthermore, from a result of the BER measurement with respect to the sector area SCT3, BER2(TRN, N(0)) when the influence of adjacent tracks is not considered is obtained. Through the above procedure, BER(TRN, N(0)) of the peripheral tracks in the case where data are written once to the sector areas SCT1, SCT2, and SCT3 of the central track TR(0) is obtained (Step S208).

BER(TRN, N(0)) is compared to BER threshold TH_B(TRN) preset with respect to track TR(TRN), (Step S209). If the BER(TRN, N(0)) exceeds TH_B(TRN) (Yes in Step S209), N(0) at that time is set as write number threshold with respect to the track TR(TRN), and is stored in a memory or the like (Step S210). Specifically, in step S209, if BER1(TRN, N(0))>TH_B(TRN), then in step S210, the write number threshold TH_W1(TRN) is set to N(0), and stored in a volatile memory 70 or the like.

Also, in step S209, if BER2(TRN, N(0))>TH_B(TRN), then in step S210, the write number threshold TH_W2(TRN) is set to N(0), and stored in a volatile memory 70 or the like. The write number threshold TH_W1(TRN) is a write number threshold when the influence of adjacent writes is considered, and the write number threshold TH_W2(TRN) is a write number threshold when the influence of adjacent writes is not considered. Note that, TH_B(TRN) may be different from both BER1(TRN, N(0)) and BER2(TRN, N(0)). Furthermore, TH_B(TRN) may be a value for each TRN, or it may be a value for all TRNs.

After performing steps S207 to S211 with respect to all tracks TR(TRN), whether or not all write number thresholds TH_W1(TRN) and TH_W2 (TRN) are acquired with respect to all tracks TR(TRN), and if not, the processes from step S205 and thereafter are repeated (No in Step S212). If they have been obtained (Yes in Step S212), minimum values are extracted from each of the write number thresholds TH_W1(TRN) and TH_W2(TRN) acquired with respect to all peripheral tracks, and the extracted values are determined as the write number thresholds TH_W1 and TH_W2 (Step S213).

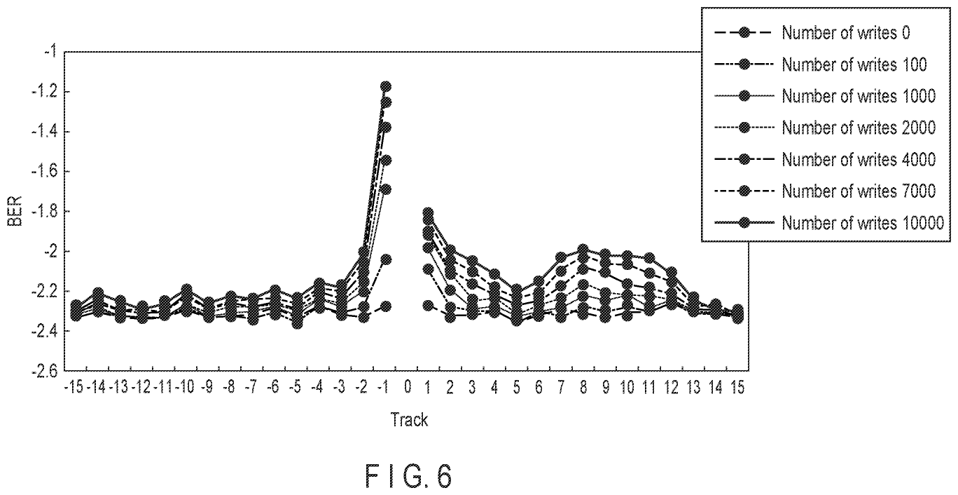

FIG. 6 is a diagram illustrating an example of the influence of side erase per track obtained by the side erase measuring method of the first embodiment, and an example of BER per peripheral track obtained from the flowchart of FIG. 5.

FIG. 6 illustrates cases where the number of writes N(0) to the central track TR(0) is set to 0, 100, 1000, 2000, 4000, 7000, and 10000, and illustrates examples of results of BERs obtained with respect to the peripheral tracks TR with TRN=˜15 to 15, where the horizontal axis indicates track numbers, and vertical axis indicates BERs. From FIG. 6, it is confirmed that the write number dependence where BER of peripheral tracks increases as the write number N(0) increases.

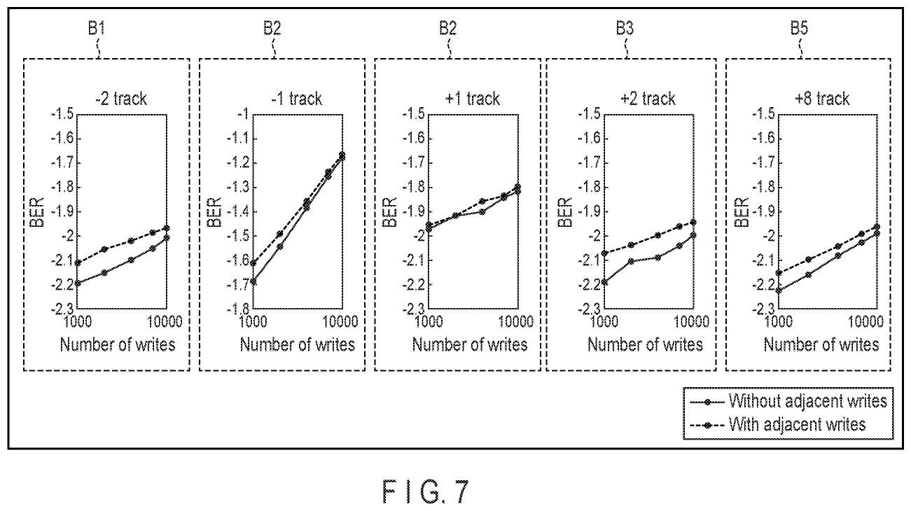

FIG. 7 illustrates an example of the write number dependence obtained by the side erase measuring method of the first embodiment.

Characteristics B1, B2, B3, B4, and B5 indicate examples of the BERs of track TR of the peripheral tracks TRN=−2, −1, +1, +2, and +8, respectively, where the BERs are measured after the write number N(0) to the center track TR(0) is set to 1000, 2000, 4000, 7000, and 10000 times, respectively. Each indicates BER characteristics of cases with adjacent writes obtained from sector areas SCT1 and SCT2 and without adjacent writes obtained from sector area SCT3. As indicated by each of BER characteristics B1, B2, B3, B4, and B5, a linear dependence is shown between the logarithm of the number of writes and the BER. Based on the obtained data of the above dependence, for example, the maximum number which does not exceed the allowable BER threshold (TH_B(TRN) of step S209 of FIG. 5) is used as the write number threshold to acquire the write number threshold. Furthermore, as a method of acquiring the write number threshold of each track, for example, from a linear approximation of the logarithm of the write number and BER obtained from the data of the above dependence, the maximum write number which does not exceed the BER threshold, and it may be set as the write number threshold. Specifically, BERs are measured for 1000, 2000, 4000, 7000, 10000 times, a linear approximation formula for BER is calculated to derive the number of writes that is the BER threshold.

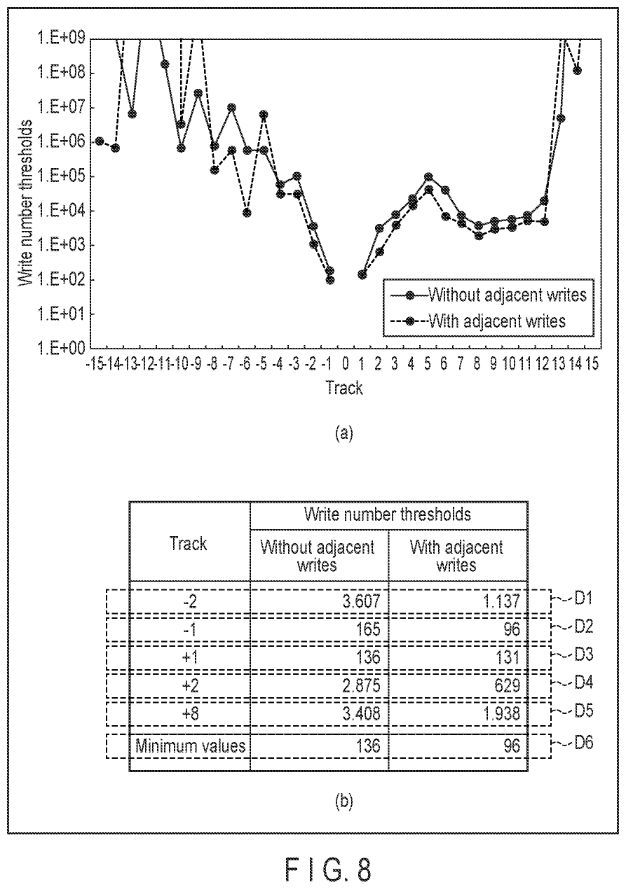

FIG. 8 is a diagram illustrating shows an example of the write number threshold for each track obtained by the side erase measuring method of the first embodiment.

FIG. 8(a) illustrates example of the write number thresholds TH_W1(TRN), TH_W2(TRN) determined in step S210 of FIG. 5, and an example of results of measurement with respect to peripheral tracks of TRN=−15 to 15.

FIG. 8(b) illustrates an example where the write count thresholds TH_W1(TRN) and TH_W2(TRN) with respect to the peripheral tracks of TRN=−2, −1, +1, +2, and +8 are extracted from FIG. 8(a).

For example, data D1 indicates that the write number threshold TH_W1 of TR(−2) is 3607 and TH_W2(−2) thereof is 1137. D6 in FIG. 8 (b) indicates examples of the write number thresholds TH_W1 and TH_W2 obtained in step S213 of FIG. 5, which are 136, and 96, respectively, as the minimum values extracted from the write number thresholds TH_W1(TRN) and TH_W2(TRN) with respect to peripheral tracks of TRN=−2, −1, +1, +2, +8. The write count thresholds TH_W1 and TH_W2 are, for example, used as TH_W shown in step S103 of FIG. 3. TH_W=TH_W1 (when adjacent writes are considered) TH_W=TH_W2 (when adjacent writes are not considered).

By applying the thresholds obtained by the above procedure to the flowchart of FIG. 3, the refresh process performed in consideration of the influence of adjacent tracks can be achieved.

### Second Embodiment

In the present embodiment, explained is an example where adjacent write number N_A(TRN) is counted, when writes are made to track TR(TRN), using the write number thresholds TH_W1(TRN) and TH_W2(TRN) obtained from the side erase measuring method of the first embodiment. A counter 62 in this example includes an adjacent write counter that counts the adjacent write number N_A(TRN) for each track.

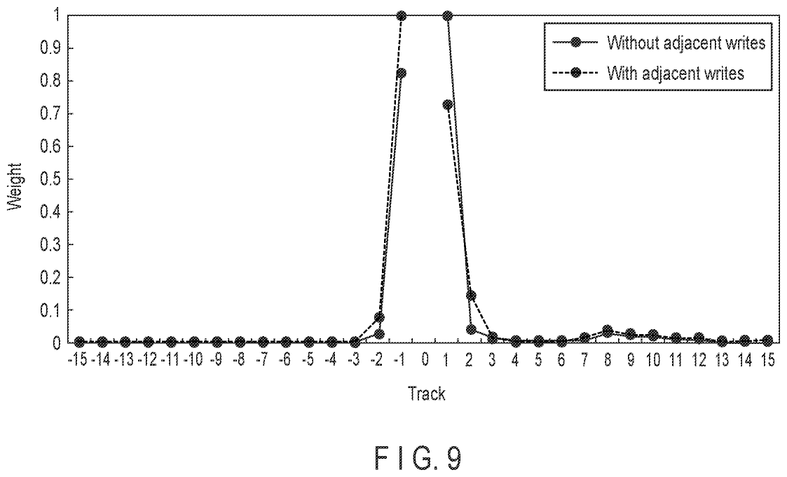

FIG. 9 illustrates an example of a track profile weight table obtained by the side erase measuring method of the second embodiment.

The track profile weights are obtained for a case with adjacent writes (TPW1) and without adjacent writes (TPW2). TPW1 and TPW2 (collectively denoted as TPW) are each acquired using the write number thresholds TH_W1(TRN) and TH_W2(TRN) per track as in FIG. 8 (a), and the write number thresholds TH_W1 and TH_W2 which are the minimum values acquired in step S213 of FIG. 5. Given that he track profile weight TPW of track TR(TRN) is TPW(TRN), TPW(TRN) will be derived according to the followings formulae.

TPW1(TRN)=TH_W1/TH_W1(TRN)

TPW2(TRN)=TH_W2/TH_W2(TRN)

TPW indicates the weight for the number of writes by side erase, and the track profile weight table is stored in a non-volatile memory 90, for example, in advance, and an adjacent write number N_A(TRN) of data with respect to peripheral tracks is used for count.

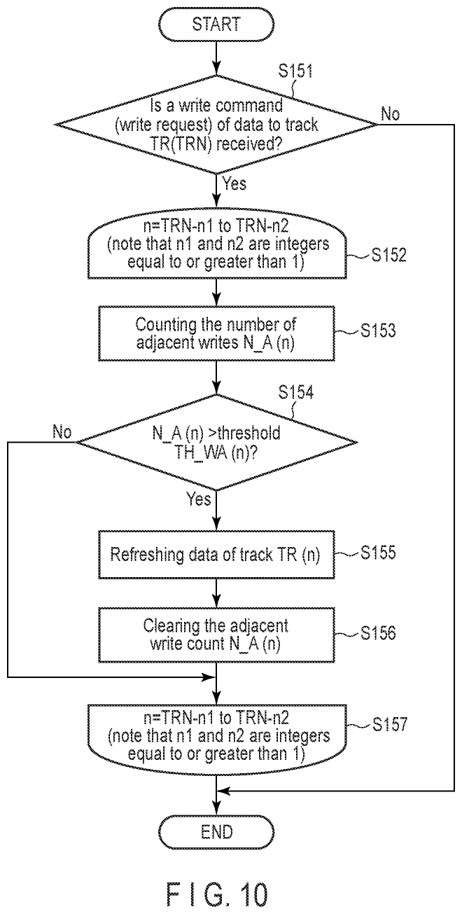

FIG. 10 is a flowchart illustrating the processing actions of the refresh process performed by the magnetic disk device of the second embodiment.

HDC 50 receives a write command (write request) of data to track TR(TRN) of track number TRN from a host 2 (Step S151). MPU 60 counts write number N(n) of peripheral tracks TR(n) of the track TR(TRN) in steps S153 to S156, where n indicates TRN-n1 to TRN-n2 (note that n1 and n2 are integers equal to or greater than 1), which are inward and outward peripheral track number with respect to track TR(TRN) where the track TR(TRN) is set as the center track.

The counter 62 counts the number of adjacent writes N_A(n) (Step S153). In step S153, the counter 62 obtains weight TPW(n) of a target peripheral track TR(n) from the track profile weight table and counts as follows such that it is increased by TPW.

N_A(n)=N_A(n)+TPW(n)

N_A(n)=N_A(n)+TPW1(n) (when track weight TPW1 is used)

N_A(n)=N_A(n)+TPW2(n) (when track weight TPW2 is used)

The refresh processor 63 compares a preset threshold TH_WA(n) with N_A(n) (Step S154). TH_WA(n) may be a threshold set for each track TR(n) or a constant threshold regardless of n.

If N_A(n)>TH_WA(n), data of track TR(n) are refreshed (Yes in Step S154, Step S155). If N_A(n)<TH_WA(n), the process is performed from step S153 with respect to the next track TR(n) (No in Step S154). In step S155, after the data in track TR(n) are refreshed, the adjacent write count N_A(n) is cleared to 0 or the like (Step S156).

The above procedure enables refresh processing by a counting process in which the influence of side erase with respect to the peripheral tracks is considered using a track profile weight table.

### Third Embodiment

In the present embodiment, a method of determining a threshold TH_W used in the first embodiment based on adjacent write number is shown. In addition to the write number N(TRN) of data to track TR(TRN), adjacent write number N_A(TRN) of data with respect to adjacent tracks TR(TRN+1) and (TRN−1) of the track TR(TRN) is counted.

The counter 62 of the present embodiment includes a write counter which counts the number of writes N(TRN) per track and an adjacent write counter which counts the number of adjacent writes N_A(TRN) per track.

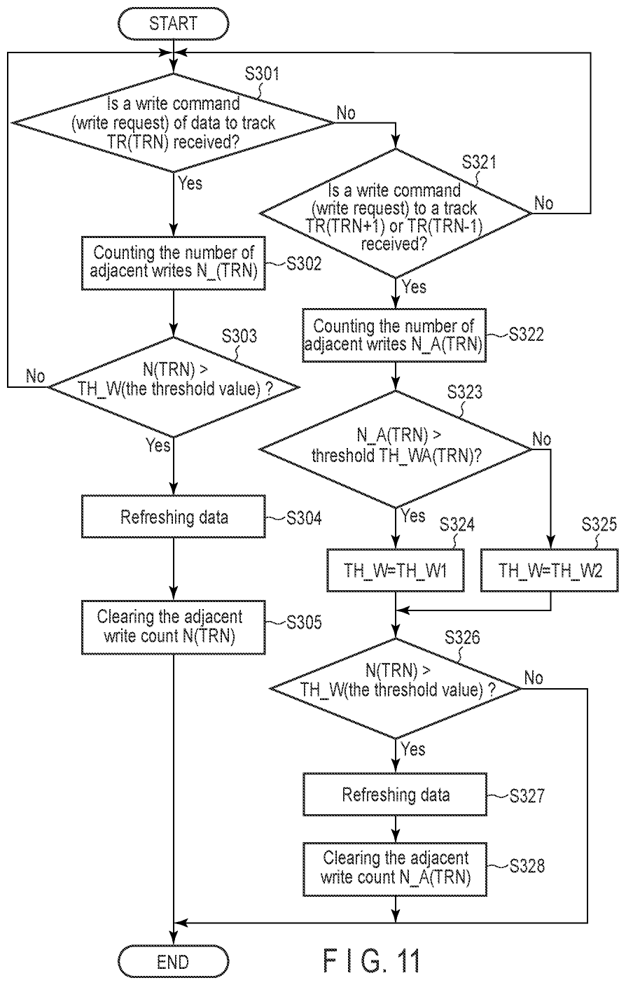

FIG. 11 is a flowchart of the processing actions of the refresh process performed by the magnetic disk device of the third embodiment.

Steps S301 to S305 are similar to steps S101 to S105 of FIG. 3 explained in the first embodiment, and thus the explanation thereof is omitted. Note that, in the present embodiment, if write to a track other than track TR(TRN) is performed (No in Step S301), the process proceeds to step S321.

In step S321, if a write request to tracks TR(TRN−1) and TR(TRN+1) which are adjacent tracks to the track TR(TRN) from the host 2 (YES in this step) is received, the HDC 50 counts the adjacent write number N_A(TRN) of track TR(TRN) (Step S322). For example, if TRN=0, the counter 62 counts the adjacent write number N_A(TRN) using the track profile weight table of FIG. 9 as in the following formulae.

If written to adjacent track TR(TRN−1):

N_A(0)=NA(0)+TPW(1).

If written to adjacent track TR(TRN+1):

N_A(0)=NA(0)+TPW(−1).

That is, in step S322, if a track (in this case, TR(TRN+1) or TR(TRN−1)) is written, the track profile weight table is used to count the number of adjacent write number N_A(TRN) of TR(TRN) which is an adjacent track.

The number of adjacent write N_A(TRN) is compared with a preset threshold TH_WA, and if N_A(TRN)>TH_WA (Yes in Step S323), the threshold TH_W=TH_W1 (Step S324), and if N_A(TRN) is equal to or less than TH_WA (No in Step S323), the value TH_W=TH_W2 (Step S325). TH_W1 and TH_W2 are write number thresholds as the minimum value acquired in step S213 of FIG. 5, and the threshold TH_W is a threshold with respect to the write number N(TRN) of track TR(TRN).

N(TRN) is compared with TH_W, and if N(TRN)>TH_W (Yes in Step S326), data of adjacent tracks TR(TRN−1) and TR(TRN+1) of track TR(TRN) are refreshed (Step S327), and the adjacent write number N_A(TRN) is cleared to 0 or the like (Step S328). Furthermore, the threshold TH_W set in steps S324 or S325 is also used for comparison of write number N(TRN) of track TR(TRN) to TH_W in step S303.

The present embodiment enables the refresh process using threshold obtained with respect to the write number N(TRN) in consideration of adjacent write number N_A of adjacent tracks.

(Variation)

In this variation, an example of assigning BER measuring sectors to five sector areas is shown.

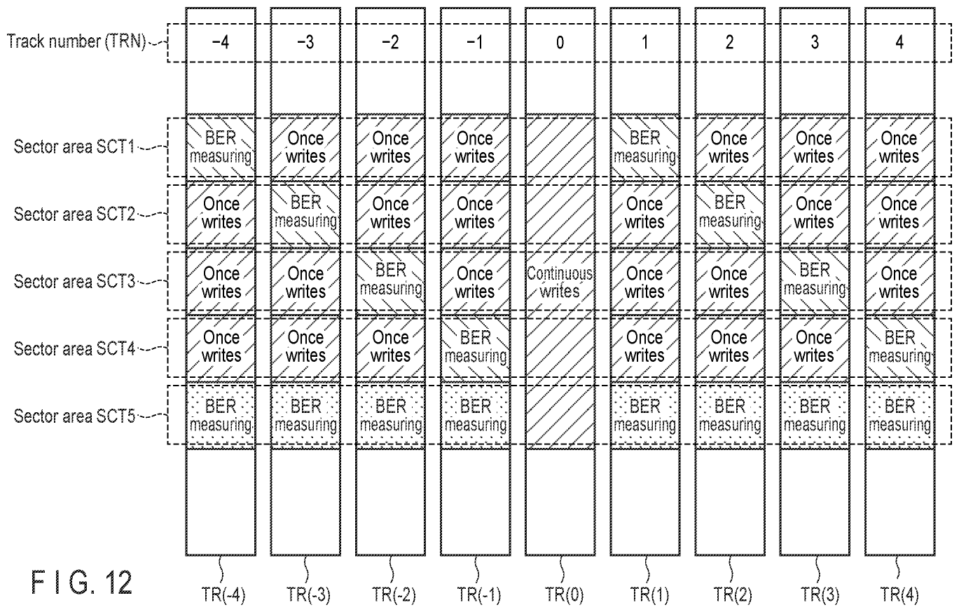

FIG. 12 is a schematic diagram illustrating a side erase measuring method of a magnetic disk device of the variation.

In the first embodiment, an example where three sector areas of FIG. 4 are used is shown, and note that, as in FIG. 12, five sector areas can be used. The sector area SCT5 of FIG. 12 corresponds to sector area SCT3 of FIG. 4, and all tracks are used as the BER measurement area. In the sector areas SCT1 to SCT4 of FIG. 12, the BER measuring sectors are allocated such that the BER measuring sectors are not adjacent to each other. In this variation, a write count threshold is obtained in the same way as in the first embodiment. According to this variation, the number of sector areas SCT to which the BER measurement areas are allocated can be determined arbitrary.

According to at least one of the aforementioned embodiments, a side erase measuring method and a refresh process method, which are to improve the reliability of data can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A side erase measuring method used in a disk-shaped magnetic disk including a plurality of tracks which are areas defined concentrically from a center part in a radial direction and a plurality of sectors defined in a circumferential direction, the method comprising:
selecting one center track from the tracks and a plurality of peripheral tracks continuous from tracks adjacent to the center track concentrically outward and inward in the radial direction, and a plurality of target sectors;
selecting a bit error rate (BER) measuring sector to measure a BER from the target sectors in the peripheral tracks such that sectors differ between adjacent peripheral tracks;
counting a center track write number which is a write number per write of data to all the target sectors of the center track; and
measuring BER in the BER measuring sector per a predetermined number of the center track write number.

2. The side erase measuring method of claim 1, wherein
the BER measuring sector is allocated alternately to a first sector and a second sector which is not the first sector in the order of the first sector and the second sector in outer all peripheral tracks which are a plurality of peripheral tracks continuous concentrically outward from an outer first peripheral track adjacent to the center track outward in the radial direction,
the BER measuring sector is allocated alternately to the first sector and the second sector in the order of the second sector and the first sector in inner all peripheral tracks which are a plurality of peripheral tracks continuous concentrically inward from an inner second peripheral track adjacent to the center track inward in the radial direction, and
the target sectors other than the BER measuring sectors of the first sectors and the second sectors of the outer all peripheral tracks and the inner all peripheral tracks are set as write sectors to write data once or more.

3. The side erase measuring method of claim 2, wherein
the BER measuring sector is allocated to a third sector which is different from the first sectors and the second sectors of the outer all peripheral tracks and the inner all peripheral tracks.

4. A refresh process method of a magnetic disk using BER obtained by the side erase measuring method of claim 2, the refresh process method comprising:
setting a minimum value of write number threshold values, which are threshold values with respect to the center track write number acquired for each of the peripheral tracks based on BER measured in a BER measuring sector of a first sector and a second sector and a BER threshold value given to a plurality of peripheral tracks in advance, as a first write number threshold value; and
executing an adjacent track interference (ATI) refresh function to refresh data stored in the magnetic disk based on the first write number threshold value.

5. The refresh process method of claim 4 of the magnetic disk using BER obtained by the side erase measuring method of claim 3, the refresh process method comprising:
setting a minimum value of the write number threshold value, acquired for each of the peripheral tracks based on BER measured in a BER measuring sector of the third sector and the BER threshold, as a second write number threshold value; and
executing the ATI refresh function to refresh of data stored in the magnetic disk based on the second write number threshold value.

6. The refresh process method of claim 5, wherein refresh of data is executed based on a track profile weight table which is a data base of weight data of each of the peripheral tracks, generated by regulating a write number threshold value based on the first write number threshold value and the second write number threshold value.

7. The refresh process method of claim 6, in a second refresh process method in which, if data are written in a first track, adjacent write number is counted per peripheral track of the first track, and data of the peripheral track are refreshed based on the adjacent write number, the method comprising:
counting the adjacent write number based on weight data of the peripheral track of the track profile weight table at each time when data are written to the first track.

8. The refresh process method of claim 5, comprising:
executing refresh of data of a peripheral track of a second track based on the first write number threshold value if an adjacent write number counted with respect to the peripheral track of the second track is equal to or more than an adjacent write number threshold value; and
executing refresh of data of a peripheral track of the second track based on the second write number threshold value if the adjacent write number is below the adjacent write number threshold value.
